(19) United States
(12) Patent Application Publication
(10) Pub. No.: US 2012/0224035 A1
(43) Pub. Date: Sep. 6, 2012

(54) ELECTRONIC APPARATUS AND IMAGE PROCESSING METHOD

(76) Inventor: Akihiko Noguchi, Ome-shi (JP)

(21) Appl. No.: 13/302,827

(22) Filed: Nov. 22, 2011

(30) Foreign Application Priority Data
Mar. 4, 2011 (JP) 2011-048290

(51) Int. Cl. H04N 13/04

(52) U.S. Cl. 348/54; 348/E13.075

(57) ABSTRACT

According to one embodiment, an electronic apparatus includes a depth estimation module, a parallax calculation module, a video generation module, a sub-image parallax determination module, a sub-image generation module, and a display control module. The depth estimation module estimates depths corresponding to pixels in a frame of video data. The parallax calculation module calculates parallaxes by using the depths. The video generation module generates left-eye and right-eye video data by using the video data and the parallaxes. The sub-image parallax determination module determines (i) a first depth for displaying a sub-image and (ii) a first parallax by using the first depth. The sub-image generation module generates left-eye and right-eye sub-image data by using sub-image data and the first parallax. The display control module displays a left-eye image and a right-eye image by using the generated data.

### CROSS-REFERENCE TO RELATED APPLICATIONS

This application is based upon and claims the benefit of priority from prior Japanese Patent Application No. 2011-048290, filed Mar. 4, 2011, the entire contents of which are incorporated herein by reference.

### FIELD

Embodiments described herein relate generally to an electronic apparatus which reproduces three-dimensional (3D) video content, and an image processing method applied to the electronic apparatus.

### BACKGROUND

In recent years, various video display apparatuses for viewing 3D video are provided. In such a video display apparatus, for example, a user is enabled to perceive 3D video (stereoscopic video) with use of left-eye video and right-eye video based on binocular parallax.

In general, most of video contents, which are received via broadcast or networks, are video content data including two-dimensional (2D) video. In order to view 3D video by using such video content data, various 2D to 3D conversion techniques are proposed for converting 2D video to 3D video.

In the meantime, video content data may include caption data for displaying a caption on video.

In video content data for 2D video, a caption is displayed, for example, at a predetermined position on 2D video (screen). In addition, in order to display a caption on 3D video, it is necessary to designate not only the position on the screen on which the caption is displayed, but also a position in a depth direction. For this purpose, there has been proposed a technique for storing caption data and a parameter in video content data for 3D video. The parameter indicates a depth at which a caption is displayed. For example, a distance from a user is set as the depth. Thereby, the user can view a caption on 3D video at a fixed depth.

However, depths of a plurality of pixels included in 3D video vary from pixel to pixel, and the range of depths of the pixels varies from frame to frame. Thus, in the case of displaying a caption at a fixed position, when the depth of video is in front of the depth of the caption, it is possible that the caption is viewed as if they sink in the video. In addition, when the depth at which a caption is displayed is set sufficiently in front of the depths of pixels in the video, thereby to prevent the caption from sinking in the video, the user has to greatly move the line of sight (in-focus position) in order to view the caption and video, leading to a cause of eye strain.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment.

FIG. 2 is an exemplary block diagram illustrating the system configuration of the electronic apparatus of the embodiment.

FIG. 3 is an exemplary conceptual view showing an example of a caption which is displayed on 3D video.

FIG. 4 is an exemplary conceptual view showing another example of a caption which is displayed on 3D video.

FIG. 5 is an exemplary conceptual view showing an example of a caption which is displayed on 3D video by the electronic apparatus of the embodiment.

FIG. 6 is an exemplary conceptual view showing another example of a caption which is displayed on 3D video by the electronic apparatus of the embodiment.

FIG. 7 is an exemplary block diagram illustrating an example of the functional structure of a video content reproduction application which is executed by the electronic apparatus of the embodiment.

FIG. 8 is an exemplary view for explaining a 3D space in which 3D video is displayed by the electronic apparatus of the embodiment.

FIG. 9 is another exemplary view for explaining the 3D space in which 3D video is displayed by the electronic apparatus of the embodiment.

FIG. 10 is still another exemplary view for explaining the 3D space in which 3D video is displayed by the electronic apparatus of the embodiment.

FIG. 11 is an exemplary view for explaining a parallax which is calculated by the electronic apparatus of the embodiment.

FIG. 12 is another exemplary view for explaining the parallax which is calculated by the electronic apparatus of the embodiment.

FIG. 13 is an exemplary flowchart illustrating the procedure of a video content reproduction process which is executed by the electronic apparatus of the embodiment.

FIG. 14 is an exemplary flowchart illustrating the procedure of a caption parallax determination process which is executed by the electronic apparatus of the embodiment.

### DETAILED DESCRIPTION

Various embodiments will be described hereinafter with reference to the accompanying drawings.

In general, according to one embodiment, an electronic apparatus, which reproduce three-dimensional video by using video content data including video data and sub-image data, includes a depth estimation module, a parallax calculation module, a video generation module, a sub-image parallax determination module, a sub-image generation module, and a display control module. The depth estimation module estimates a plurality of depths corresponding to a plurality of pixels in a first image frame of a plurality of image frames of the video data, the first image frame being a target of processing. The parallax calculation module calculates a plurality of parallaxes corresponding to the plurality of pixels by using the plurality of depths. The video generation module generates left-eye video data and right-eye video data by using the video data and the plurality of parallaxes. The sub-image parallax determination module determines a first depth for displaying a sub-image based on the plurality of depths, and determines a first parallax corresponding to the sub-image by using the first depth. The sub-image generation module generates left-eye sub-image data and right-eye sub-image data by using the sub-image data and the first parallax. The display control module displays a left-eye image by using the left-eye video data and the left-eye sub-image data, and displays a right-eye image by using the right-eye video data and the right-eye sub-image data.

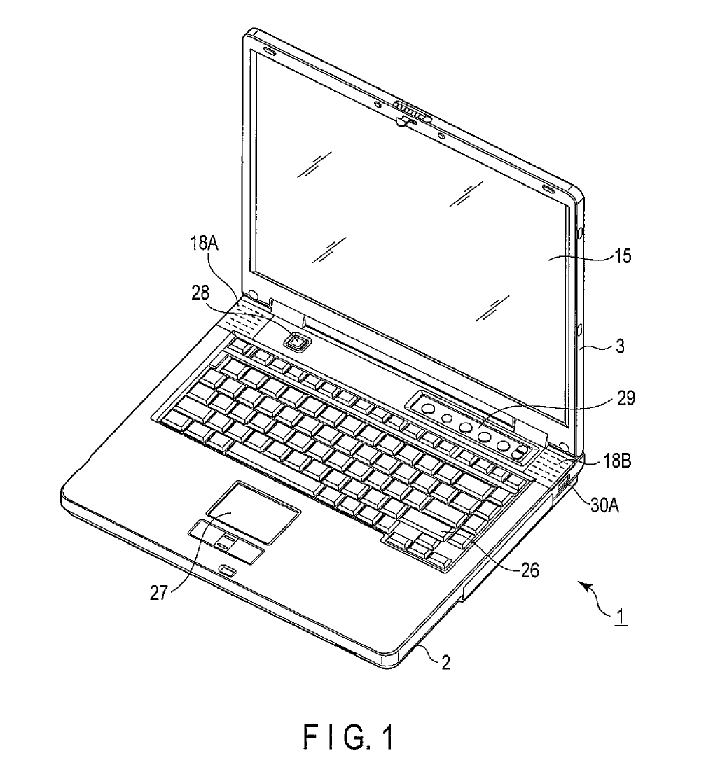

FIG. 1 is a perspective view showing the external appearance of an electronic apparatus according to an embodiment. The electronic apparatus is realized, for example, as a notebook-type personal computer (PC) 1. In addition, this electronic apparatus may be realized as a television (TV) receiver, a recorder for storing video data (e.g. a hard disk recorder or a DVD recorder), a tablet PC, a slate PC, a PDA, a car navigation apparatus, or a smartphone.

As shown in FIG. 1, the computer 1 includes a computer main body 2 and a display unit 3.

A liquid crystal display (LCD) 15 is built in the display unit 3. The display unit 3 is attached to the computer main body 2 such that the display unit 3 is rotatable between an open position where the top surface of the computer main body 2 is exposed, and a closed position where the top surface of the computer main body 2 is covered.

The computer main body 2 has a thin box-shaped housing. A keyboard 26, a power button 28 for powering on/off the computer 1, an input operation panel 29, a touch pad 27, and speakers 18A and 18B are disposed on the top surface of the housing of the computer main body 2. Various operation buttons are provided on the input operation panel 29. The buttons include operation buttons for controlling a TV function (viewing, recording and playback of recorded broadcast program data/video data).

An antenna terminal 30A for TV broadcast is provided, for example, on a right-side surface of the computer main body 2. In addition, an external display connection terminal supporting, e.g. the high-definition multimedia interface (HDMI) standard is provided, for example, on a rear surface of the computer main body 2. This external display connection terminal is used for outputting video data (moving picture data) included in video content data, such as broadcast program data, to an external display.

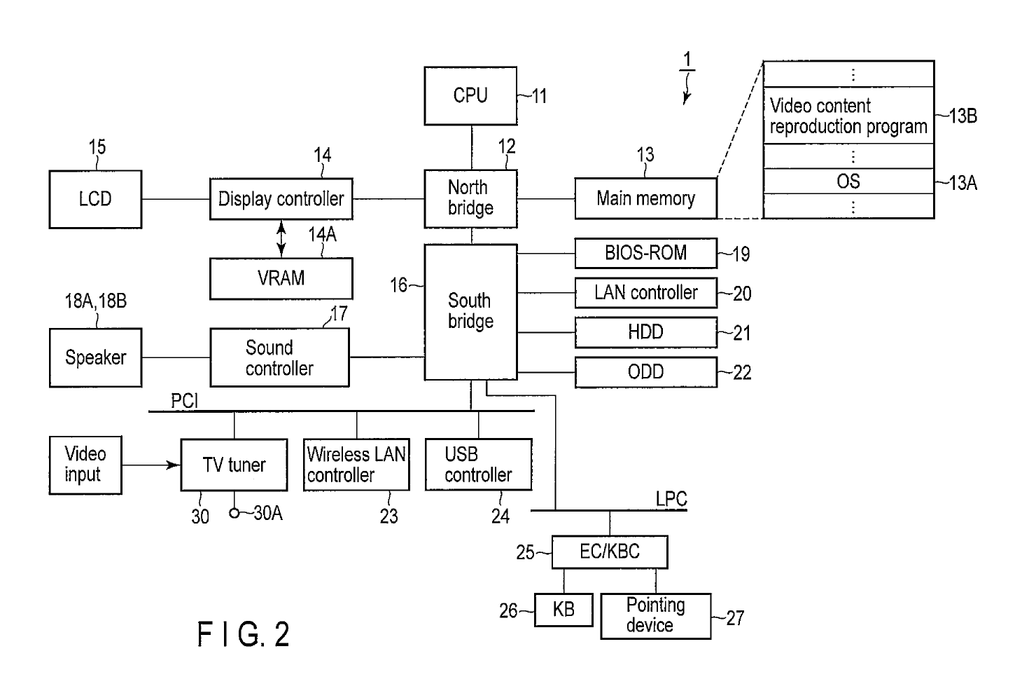

FIG. 2 shows the system configuration of the computer 1.

The computer 1, as shown in FIG. 2, includes a CPU 11, a north bridge 12, a main memory 13, a display controller 14, a video memory (VRAM) 14A, the liquid crystal display (LCD) 15, a south bridge 16, a sound controller 17, the speakers 18A and 18B, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, the keyboard (KB) 26, the pointing device 27, and a TV tuner 30.

The CPU 11 is a processor for controlling the operation of the computer 1. The CPU 11 executes an operating system (OS) 13A and an application program, such as a video content reproduction program 13B, which are loaded from the HDD 21 into the main memory 13. The video content reproduction program 13B is software having a function for viewing video content data. The video content reproduction program 13B executes a live reproduction process for viewing broadcast program data which is received by the TV tuner 30, a recording process for recording the received broadcast program data in the HDD 21, a reproduction process for reproducing broadcast program data/video data which is recorded in the HDD 21, and a reproduction process for reproducing video content data which is received via a network. In addition, the video content reproduction program 13B can reproduce video content data which is stored in storage media such as a DVD, or in a storage device such as a hard disk. Further, the video content reproduction program 13B includes a function for viewing 3D video. The video content reproduction program 13B converts 2D video, which is included in video content data, to 3D video in real time, and displays the 3D video on the screen of the LCD 15. The video content reproduction program 13B can 2D-3D convert various content data (e.g. broadcast program data, video data stored in storage media such as a DVD, or video data received from a server on the Internet).

For the display of 3D video, for example, a shutter method (also referred to as “time-division method”) is also used. In the 3D video display by the shutter method, a stereo-pair video including left-eye video data and right-eye video data is used. The LCD 15 is driven at a refresh rate (e.g. 120 Hz) which is double higher than the normal refresh rate (e.g. 60 Hz). The left-eye frame data in the left-eye video data and the right-eye frame data in the right-eye video data are alternately displayed on the LCD 15 with a refresh rate of, e.g. 120 Hz. For example, by using 3D glasses (not shown) such as liquid crystal shutter glasses, the user can view the image corresponding to the left-eye frame by the left eye and the image corresponding to the right-eye frame by the right eye. The 3D glasses may be configured to receive a synchronization signal, which indicates a display timing of the left-eye frame data and right-eye frame data, from the computer 1 by using, e.g. infrared. The left-eye shutter and right-eye shutter in the 3D glasses are opened or closed in synchronization with the display timing of the left-eye frame data and right-eye frame data on the LCD 15.

Alternatively, for the display of 3D video, a polarization method such as an Xpol method may be used. In this case, for example, interleaved frames, in which a left-eye image and a right-eye image are interleaved in units of a scanning line, are generated, and the interleaved frames are displayed on the LCD 15. The left-eye image is displayed, for example, in odd-numbered lines on the screen of the LCD 15. The right-eye image is displayed, for example, in even-numbered lines on the screen of the LCD 15. A polarizing filter covering the screen of the LCD 15 polarizes the left-eye image and the right-eye image by polarizing the odd-numbered lines and the even-numbered lines in different directions. By using polarization glasses, the user can view the left-eye image by the left eye and the right-eye image by the right eye.

Furthermore, for the display of 3D video, a display device by a naked-eye stereoscopic method such as a lenticular method or a barrier method. The user can perceive 3D video by viewing video displayed on the display device of the naked-eye stereoscopic method.

Besides, the CPU 11 executes a basic input/output system (BIOS) that is stored in the BIOS-ROM 19. The BIOS is a program for hardware control.

The north bridge 12 is a bridge, device which connects a local bus of the CPU 11 and the south bridge 16. The north bridge 12 includes a memory controller which access-controls the main memory 13. The north bridge 12 also has a function of communicating with the display controller 14.

The display controller 14 is a device which controls the LCD 15 that is used as a display of the computer 1. A display signal, which is generated by the display controller 14, is sent to the LCD 15. The LCD 15 displays video based on the display signal.

The south bridge 16 controls devices on a peripheral component interconnect (PCI) bus and devices on a low pin count (LPC) bus. The south bridge 16 includes an integrated drive electronics (IDE) controller for controlling the HDD 21 and ODD 22, and a memory controller which access-controls the BIOS-ROM 19. The south bridge 16 also has a function of communicating with the sound controller 17 and LAN controller 20.

The sound controller 17 is a sound source device and outputs audio data, which is a target of playback, to the speakers 18A and 18B. The LAN controller 20 is a wired communication device which executes wired communication of, e.g. the Ethernet standard. The wireless LAN controller 23 is a wireless communication device which executes wireless communication of, e.g. the IEEE 802.11 standard. In addition, the USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the computer 1 in accordance with the user's operation.

The TV tuner 30 is a reception device which receives broadcast program data that is broadcast by a television (TV) broadcast signal. The TV tuner 30 is connected to the antenna terminal 30A. The TV tuner 30 is realized as a digital TV tuner which can receive a digital broadcast program data of, e.g. terrestrial digital TV broadcast. In addition, the TV tuner 30 has a function of capturing video data which is output from an external device.

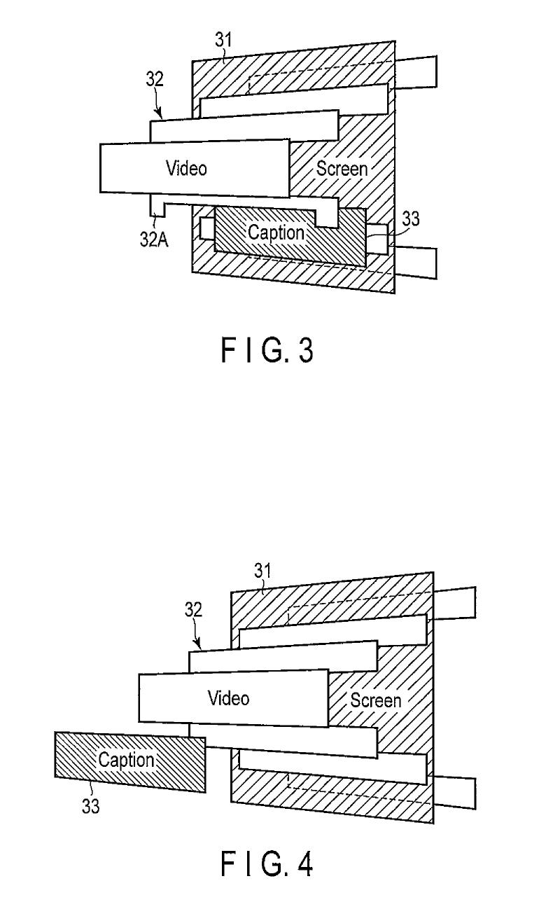

Next, referring to FIGS. 3 and 4, a description is given of examples of a caption which is displayed on 3D video.

In the example shown in FIG. 3, when 3D video 32 is displayed, a caption 33 is displayed at a depth at which a screen 31 (display 15) is actually present. In general, since the caption 33 is displayed in preference to the video 32, the caption 33 is rendered, for example, such that the caption is written over the video 32. In the example shown in FIG. 3, since the caption 33 is displayed at a position deeper than the video 32, a partial area 32A of the video 32 is missing and the caption 33 are viewed such that the caption 33 sink in the video 32. It is thus possible that the user may feel difficulty in viewing the caption 33 or may feel unnaturalness of the video 32 in which the caption 33 sink.

In the example shown in FIG. 4, a caption 33 is displayed at a depth, which is sufficiently in front of a depth at which the video 32 can be displayed. Thereby, the caption 33 is not viewed such that they sink in the video 32. However, the user has to greatly move the line of sight (in-focus position) in order to view the caption 33 and video 32, leading to a cause of fatigue.

Specifically, the depth at which the video 32 is displayed varies from pixel to pixel included in the video 32. In addition, the range of depths of the pixels included in the video 32 varies from image frame to image frame. Thus, since the distance between the caption 33 and the video 32 may increase when the caption 33 is displayed at a fixed position, the user has to largely move the line of sight in order to view both the captions 33 and video 32.

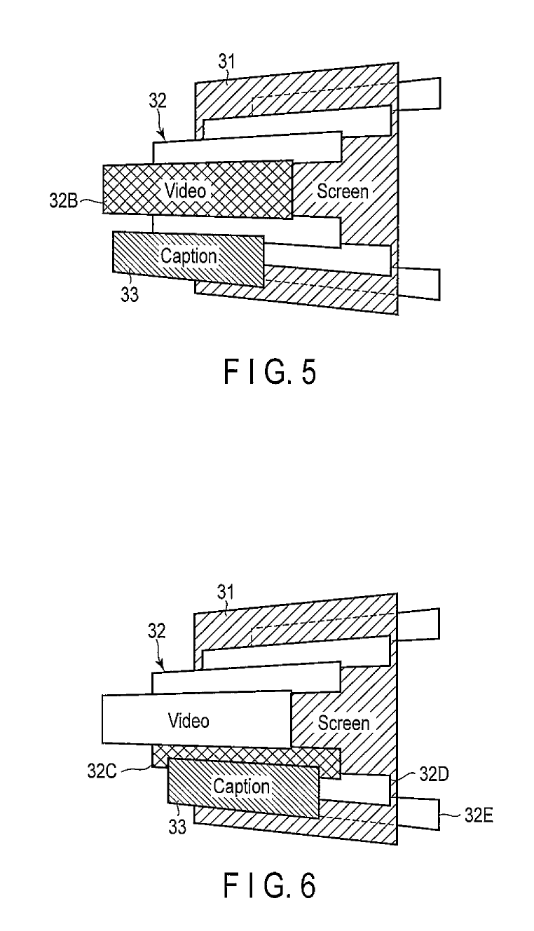

Taking the above into account, in the present embodiment, the depth, at which the caption (also referred to as a sub-image) 33 is displayed, is dynamically varied in accordance with the video 32, and thereby the positional relationship, with which both the video 32 and caption 33 can easily be visually recognized, is maintained. FIGS. 5 and 6 show examples in which the caption 33 is displayed in accordance with the video 32.

In the example shown in FIG. 5, the caption 33 is displayed at the same depth as a foremost foreground pixel (i.e. a most projecting pixel) 32B of the pixels included in the video 32. In the example shown in FIG. 6, the caption 33 is displayed in front of a foremost foreground pixel (area) 32C of the pixels (in FIG. 6, parts of areas 32C, 32D and 32E) corresponding to the area on the screen 31 on which caption is displayed. In the examples shown in FIGS. 5 and 6, the caption 33 is not viewed such that it sink in the video 32, and the strain on the eyes due to viewing the video 32 and caption 33 can be reduced.

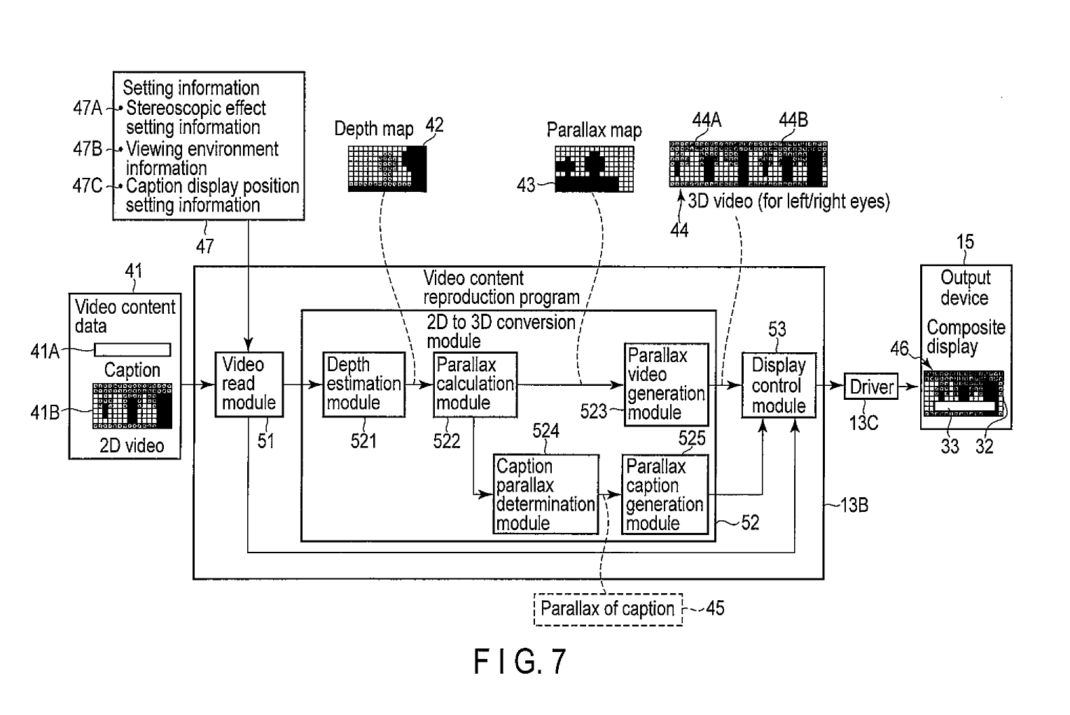

FIG. 7 illustrates the functional structure of the video content reproduction program 13B. The video content reproduction program 13B has a 3D video reproduction function for reproducing 3D video 46 in which caption 33 is superimposed on the video 32, by using video content data 41. In the example shown in FIG. 7, the 3D video 46 is displayed on the output device (display) 15 by the video content reproduction program 13B and a display driver program 13C.

The video content reproduction program 13B includes a video read module 51, a 2D to 3D conversion module 52 and a display control module 53. The 2D to 3D conversion module 52 includes a depth estimation module 521, a parallax calculation module 522, a parallax video generation module 523, a caption parallax determination module 524, and a parallax caption generation module 525.

The video read module 51 reads the video content 41 from storage medium such as a DVD, or from a storage device such as the HDD 21. The video read module 51 may receive the video content data 41 via the TV tuner 30, the LAN controller 20, 23, etc. The video content data 41 includes sub-image data (also referred to as “caption data”) 41A and 2D video data 41B. The 2D video data 41B is, for example, compression-encoded video data. In this case, the 2D video data 41B is decoded and used. The sub-image data 41A is, for example, image data including a caption. Meanwhile, the sub-image data 41A may be text data representing a caption. In this case, based on the text data representing the caption, image data including text (caption) is generated. Besides, the sub-image data 41A may include caption data, on-screen display (OSD) data, and data for displaying a control panel for operating various application programs. The control panel may include buttons, menus, etc.

The video read module 51 extracts the caption data 41A and 2D video data 41B from the read (received) video content data 41. The video read module 51 sets a first image frame, among a plurality of frames based on the extracted 2D video data 41B, to be an image frame that is a target of processing. Specifically, the video read module 51 successively sets the plural frames based on the extracted 2D video data 41B, in the order from the first image frame, to be the image frame (target image frame) that is the target of processing. In the description below, the target image frame is also referred to as “N-th image frame”. In addition, an image frame, which immediately precedes the target image frame, is referred to as “(N−1)-th image frame”.

The video read module 51 sets caption data corresponding to the target image frame, among the extracted caption data 41A, to be caption data that is a target of processing. Then, the video read module 51 outputs the set image frame and caption data, which are the targets of processing, to the 2D to 3D conversion module 52.

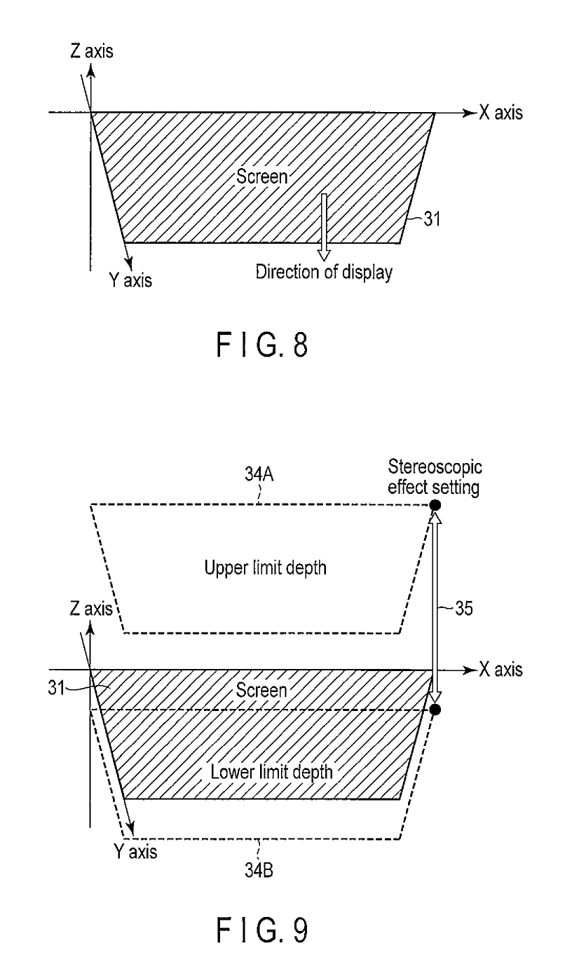

In addition, the video read module 51 reads setting information which is stored in the storage device such as the HDD 21. The setting information 47 includes stereoscopic effect setting information 47A, viewing environment information 47B and caption display position setting information 47C. The stereoscopic effect setting information 47A includes information indicative of the range of depths in a real space, which can be taken by pixels included in the 3D video 46. The viewing environment information 47B includes information indicative of an eye separation distance and information indicative of a viewing distance. The caption display position setting information 47C includes a parameter for determining a depth at which caption is to be displayed. As regards the setting information 47, a description will be given later with reference to FIGS. 8 to 12. The video read module 51 outputs the read setting information 47C to the 2D to 3D conversion module 52.

The depth estimation module 521 generates a depth map 42 by estimating depths of plural pixels in the target image frame (2D image) output by the video read module 51. The depth estimation module 521 divides, for example, an image frame into a plurality of areas, and determines a foreground/background relationship between the divided areas (e.g. whether a divided area is a background area or not, or whether a divided area is an area which exists in front of other areas), thereby determining the depths of pixels. The depth map 42 includes a plurality of depths corresponding to plural pixels included in the target image frame. The depth is, for example, an integer value in a range of −127 to 128. The depth map 42 may also be expressed as a gray scale image corresponding to the depths of the respective pixels (for example, a foreground pixel is expressed in black, and a background pixel is expressed in white). The depth estimation module 521 outputs the generated depth map 42 to the parallax calculation module 522.

FIG. 8 shows a 3D space in which the depth is estimated, that is, a space in which 3D video is displayed. In other words, the space is a space in which 3D video is perceived by the user.

The 3D space is defined as a right-handed orthogonal coordinate space by an X-axis, a Y-axis and a Z-axis. Specifically, the X-axis is a horizontal axis, which takes positive values in a rightward direction. The Y-axis is a vertical axis, which takes positive values in a downward direction. The Z-axis is a depth-directional axis, which takes positive values in a rearward direction. In addition, it is assumed that the screen 31 (i.e. the screen of the display 15), on which video is displayed, is positioned on an X-Y plane with Z=0, and the upper left apex of the screen 31 corresponds to the origin. The screen 31 displays video in a negative direction of the Z-axis. Specifically, it is assumed that the user views the screen 31 from the position of Z<0, facing straight to the screen 31.

Next, using the depth map 42 and setting information 47, which have been output from the depth estimation module 521, the parallax calculation module 522 calculates the parallax corresponding to the pixels included in the target image frame, thereby generating a parallax map 43.

To be more specific, the parallax calculation module 522 first converts the range of depths included in the depth map 42, based on the stereoscopic effect setting information 47A.

FIG. 9 shows a range 35 in the depth (Z-axis) direction in the real space in which 3D video can be displayed, the range 35 being indicated in the stereoscopic effect setting information 47A. The depth-directional range 35 is specified by an upper limit depth 34A and a lower limit depth 34B. The upper limit depth 34A indicates the upper limit of the depth at which 3D video is displayed. The lower limit depth 34B indicates the lower limit of the depth at which 3D video is displayed. Accordingly, 3D video is displayed in the space having the depth specified by the lower limit depth≦Z≦the upper limit depth. In addition, the range in the X-axis direction and the range in the Y-axis direction, in which 3D video is displayed, correspond to the screen 31. Thus, 3D video is displayed in a 3D space of the rectangular solid which is defined by the ranges corresponding to the screen 31 and the depth-directional range 35. The depth-directional range 35 is, for example, 9.5 cm.

The parallax calculation module 522 scales the depths included in the depth map 42, based on the depth-directional range 35 in the real space in which 3D video can be displayed. For example, the parallax calculation module 522 converts the depths included in the depth map 42, so that the range of the depths included in the depth map 42 correspond to the range between the lower limit depth 34B and the upper limit depth 34A. The depths included in the depth map 42 are converted to, for example, depths (e.g. millimeter unit) in the real space.

Next, based on the viewing environment information 47B, the parallax calculation module 522 calculates a parallax (e.g. millimeter unit) corresponding to the depths.

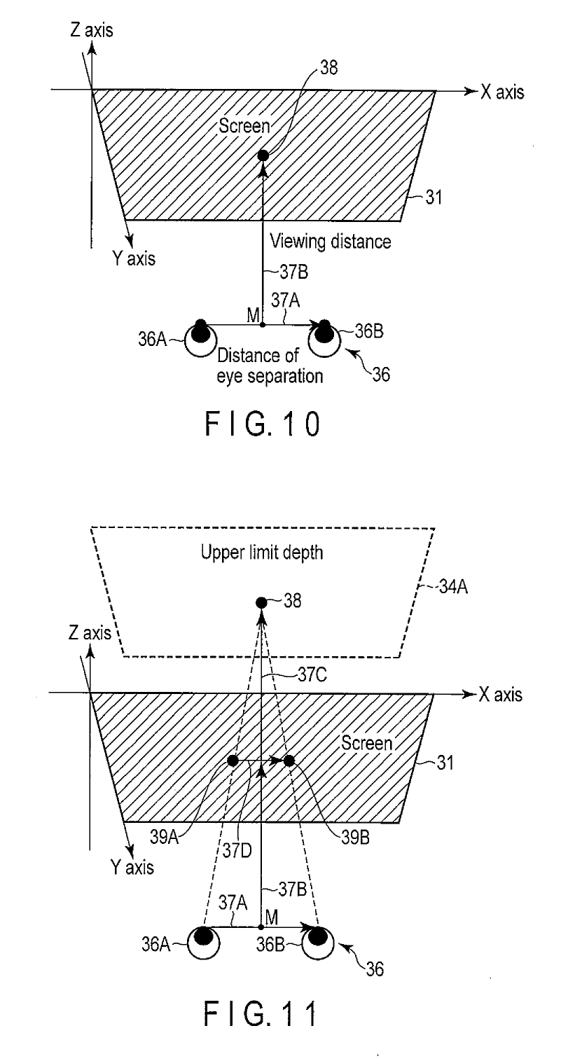

FIG. 10 shows an eye separation distance 37A and a viewing distance 37B, which are indicated in the viewing environment information 47B. The eye separation distance 37A is indicative of a distance between the left eye 36A and right eye 36B. To be more specific, the eye separation distance 37A is indicative of, for example, a distance (X_{R}−X_{L}) between a position X_{L} of the left eye 36A in the X-axis direction and a position X_{R} of the right eye 36B in the X-axis direction. As the eye separation distance 37A, use is made of, for example, the eye separation distance of the user who actually uses the electronic apparatus 1, or a statistical mean (e.g. 6.5 cm) of the eye separation distance.

The viewing distance 37B is indicative of a distance from a midpoint M between the left eye 36A and right eye 36B to the screen. To be more specific, the viewing distance 37B is indicative of, for example, a distance Z_{M} from a position Z_{M} of the midpoint M in the Z-axis direction to the screen 31 (i.e. Z=0). As the viewing distance 37B, use is made of, for example, a distance corresponding to the mode of use or the screen size of the electronic apparatus 1, or an arbitrary distance which is set by the user.

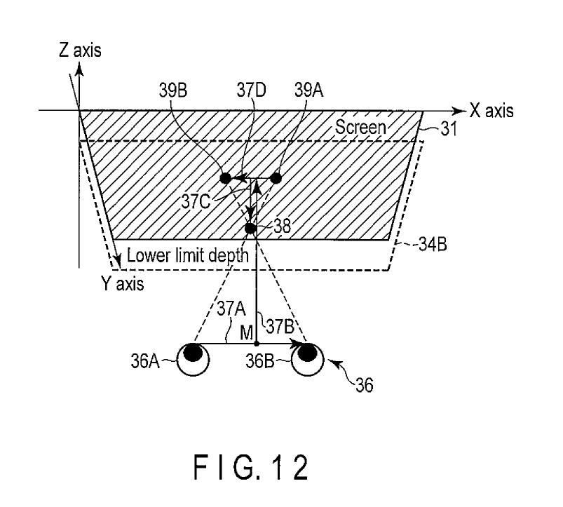

FIGS. 11 and 12 show examples of a parallax 37D which is calculated in accordance with the depths. The parallax 37D is indicative of a difference between the position of a pixel 38 (also referred to as an observation point) in 3D video at a time when the pixel 38 is viewed by the left eye 36A and the position of the pixel 38 at a time when the pixel 38 is viewed by the right eye 36B. The user can perceive a depth (stereoscopic effect) of the pixel 38 by viewing a pixel 39A in a left-eye video image 44A, which is displayed on the screen 31, by the left eye 36A, and by viewing a pixel 39B in a right-eye video image 44B by the right eye 36B. Specifically, the parallax 37B is calculated in order to determine the position of the pixel 39A in the left-eye video image 44A and the position of the pixel 39B in the right-eye video image 44B, the pixels 39A and 39B corresponding to the pixel 38.

For the purpose of simple description, it is assumed that the Y coordinate and Z coordinate of the left eye 36A are equal to the Y coordinate and Z coordinate of the right eye 36B. It is also assumed that the X coordinate and Y coordinate of the midpoint M are equal to the X coordinate and Y coordinate of the observation point 38 in the 3D video. In other words, it is assumed that a viewpoint 36 of the user is exactly opposed to the observation point 38, without inclination.

To begin with, referring to FIG. 11, a description is given of an example in which the parallax 37D corresponding to the pixel 38 having a depth 37C is calculated. The depth 37C is Z>0 (i.e. on the back side of the screen 31). The value of the eye separation distance 37A and the value of the viewing distance 37B are given by the viewing environment information 47B.

The pixel 39A in the left-eye video image 44A is positioned at a point at which a line of sight connecting the left eye 36A and the pixel 38 in 3D video crosses the screen 31. In addition, the pixel 39B in the right-eye video image 44B is positioned at a point at which a line of sight connecting the right eye. 36B and the pixel 38 in 3D video crosses the screen 31. Since

eye separation distance:(viewing distance+depth)=parallax:depth,

parallax=depth×eye separation distance/(viewing distance+depth).

Hence, the parallax 37D between the pixel 39A in the left-eye video image and the pixel 39B in the right-eye video image, which corresponds to the pixel 38 in the 3D video, is calculated.

Referring to FIG. 12, a description is given of another example in which the parallax 37D corresponding to the pixel 38 having a depth 37C is calculated. The depth 37C is Z<0 (i.e. on the front side of the screen 31). The value of the eye separation distance 37A and the value of the viewing distance 37B are given by the viewing environment information 47B.

The pixel 39A in the left-eye video image is positioned at a point at which a line of sight connecting the left eye 36A and the pixel 38 in 3D video crosses the screen 31. In addition, the pixel 39B in the right-eye video image is positioned at a point at which a line of sight connecting the right eye 36B and the pixel 38 in 3D video crosses the screen 31. Like the example shown in FIG. 11,

parallax=depth×eye separation distance/(viewing distance+depth).

Hence, the parallax 37D between the pixel 39A in the left-eye video image and the pixel 39B in the right-eye video image, which corresponds to the pixel 38 in the 3D video, is calculated.

The parallax calculation module 522 generates the parallax map 43 by calculating the parallax 37D, as described above. The parallax map 43 includes a plurality of parallaxes corresponding to a plurality of depths included in the depth map 42. In other words, the parallax map 43 includes a plurality of parallaxes corresponding to a plurality of pixels included in 2D video. The parallax is, for example, a value of the millimeter unit. The parallax map 43 can also be expressed, for example, as an image corresponding to the parallaxes of the respective pixels (e.g. the magnitude of a positive value is expressed by the density of red, and the magnitude of a negative value is expressed by the density of green). The parallax calculation module 522 outputs the generated parallax map 43 to the parallax video generation module 523. In addition, the parallax calculation module 522 outputs the depth map 42 and parallax map 43 to the caption parallax determination module 524.

The parallax video generation module 523 generates 3D video data 44 including left-eye video data 44A and right-eye video data 44B, by using the parallax map 43 output by the parallax calculation module 522 and the target image frame. Based on the resolution of the video 32, the parallax video generation module 523 converts the parallax 37D in the real space to a value (e.g. pixel unit) indicative of the parallax on the image. In the left-eye video data 44A and right-eye video data 44B, pixels are arranged at positions corresponding to the converted parallaxes 37D. To be more specific, the pixel 39A in the left-eye video data 44A and the pixel 39B in the right-eye video data 44B, which correspond to the pixel 38 in the 3D video, are disposed at positions which are displaced by the parallax/2.

In the examples shown in FIGS. 11 and 12, if the position of the pixel 38 in the 3D video in the X axis direction is X_{A}, a position X_{AL} of the pixel 39A in the left-eye video data 44A in the X axis direction and a position X_{AR} of the pixel 39B in the right-eye video data 44B, which correspond to the pixel 38, are expressed by

X_{AL}(X_{A}−parallax/2),

X_{AR}=(X_{A}+parallax/2).

The parallax video generation module 523 outputs the left-eye video data 44A and right-eye video data 44B, which have been generated as described above, to the display control module 53.

The caption parallax determination module 524 determines a parallax 45 for displaying the caption 33, by using the depth map 42 and parallax map 43.

Specifically, the caption parallax determination module 524 first determines a depth for displaying the caption 33, based on the caption display position setting information 47C. The caption display position setting information 47C includes search range information, offset information and variation upper limit value information.

The search range information is indicative of an area in the depth map 42. The area indicated in the search range information is, for example, the entirety of the depth map 42. In addition, the area indicated in the search range information is an area corresponding to the area on the X-Y plane in which the caption 33 is displayed. A candidate value (reference value) of the depth for displaying the caption 33 is detected from the area indicated in the search range information in the depth map 42.

The offset information is indicative of an offset value in the Z axis direction for adjusting the candidate value of the depth. The offset value is used, for example, in order to adjust the depth of the caption 33 in accordance with the preference of the user (viewer). Specifically, the offset value is set at a value for displaying the caption 33, for example, slightly in front of the video 32. The offset value may be zero.

The variation upper limit value information is indicative of an upper limit value of the variation per unit time of the depth of the caption 33. The depth for displaying the caption 33 varies, for example, from frame to frame. However, when the depth, at which the caption 33 is displayed, has greatly varied, the user may possibly feel difficulty in viewing the caption 33. Thus, this variation upper limit value information sets the upper limit value (threshold value) of the variation per unit time of the depth at which the caption 33 is displayed. The variation upper limit value information is, for example, 9.5 cm/sec. Accordingly, when video (image frames) of 60 frames per second is displayed, an upper limit value TH_{D} of the variation per frame is 0.16 cm.

The caption parallax determination module 524 searches the area indicated by the search range information in the depth map 42, and detects a minimum depth (i.e. a foremost depth) in the area. The detected depth is used as a candidate value (reference value) Z_{C} of the depth for displaying the caption 33. In the meantime, the depth, which is detected from the search range, is not limited to the minimum value, but may be a mean value or an intermediate value of depths included in the search range. When a pixel (area) having salient depth is locally present in the search range, a natural (preferable) depth of the caption 33 can be obtained if the mean value or intermediate value is used as the candidate depth Z_{C}.

The caption parallax determination module 524 sets a value, which is obtained by adding the offset value indicated by the offset information to the candidate depth Z_{C}, to be a new candidate depth Z_{C}.

Next, the caption parallax determination module 524 calculates a variation (e.g. an absolute value of a difference) between the candidate depth Z_{C} in the current image frame (N-th image frame) and a depth Z_{N-1} of caption in an immediately preceding image frame ((N−1)-th image frame). Then, the caption parallax determination module 524 determines whether the calculated variation is within the upper limit value TH_{D}. The upper limit value TH_{D} is, for example, 0.16 cm/frame, when it is assumed that video of 60 frames per second is displayed. When the calculated variation is within the upper limit value TH_{D}, the caption parallax determination module 524 uses the candidate depth Z_{C} as the depth Z_{N} for displaying the caption in the current image frame. On the other hand, when the calculated variation is greater than the upper limit value TH_{D}, the caption parallax determination module 524 varies the candidate depth Z_{C} so that the variation may fall within the upper limit value TH_{D}, and sets the varied candidate depth Z_{C} to be the depth Z_{N}.

Then, the caption parallax determination module 524 calculates the parallax 45 corresponding to the depth Z_{N} of the caption. In the meantime, when the depth Z_{N} is a value detected from the depth map 42 (e.g. a depth which is not adjusted based on the above-described offset value or the variation of the depth), the caption parallax determination module 524 detects the parallax corresponding to the depth Z_{N} from the parallax map 43, thereby determining the parallax 45 for displaying the caption 33. In this case, since the parallax corresponding to the depth Z_{N} is detected from the parallax map 43, there is no need to newly calculate the parallax 45 for displaying the caption 33. Thus, since the process for calculating the parallax 45 for displaying the caption 33 can be omitted, the calculation amount decreases and the load on the CPU 11, etc. can be reduced. On the other hand, when the depth Z_{N} is not a value detected from the depth map 42, the caption parallax determination module 524 calculates the parallax 45 for displaying the caption 33, by the method described with reference to FIGS. 11 and 12. The caption parallax determination module 524 outputs the determined parallax 45 to the parallax caption generation module 525.

Next, the parallax caption generation module 525 generates left-eye caption data and right-eye caption data by using the caption data 41A and the parallax 45 output by the caption parallax determination module 524. Specifically, based on the resolution of the video 32, the parallax caption generation module 525 converts the parallax 45 to a value (e.g. pixel unit) on the image. In the left-eye caption data and right-eye caption data, pixels are arranged at positions corresponding to the converted parallax 45. The concrete method is the same as the method which has been described in connection with the parallax video generation module 523. The parallax caption generation module 525 outputs the generated left-eye caption data and right-eye caption data to the display control module 53.

The display control module 53 displays left-eye video and right-eye video on the screen by using the left-eye video data 44A and right-eye video data 44B, which have been output by the parallax video generation module 523, and the left-eye caption data and right-eye caption data, which have been output by the parallax caption generation module 525. The display control module 53 outputs the left-eye video and right-eye video to the screen, for example, via the driver program 13C. Specifically, the display control module 53 displays left-eye video, in which left-eye caption is superimposed, on the screen of the display 15 by using the left-eye video data 44A output by the parallax video generation module 523, and the left-eye caption data output by the parallax caption generation module 525. In addition, the display control module 53 displays right-eye video, in which right-eye caption is superimposed, on the screen of the display 15 by using the right-eye video data 44B generated by the parallax video generation module 523, and the right-eye caption data generated by the parallax caption generation module 525.

With the above-described structure, the user views the left-eye video by the left eye 36A and the right-eye video by the right eye 36B by using, for example, 3D glasses (liquid crystal shutter glasses), thus being able to perceive 3D video. In addition, the depth of the caption 33 is dynamically determined at a position where the caption 33 is easily visually recognized in accordance with the depth of the video 32. The depth of the caption 33 is set, for example, at a position where the caption 33 does not sink in the video 32, and the distance in the depth direction between the video 32 and caption 33 is not excessively large. Moreover, the variation of the depth of the caption between image frames is controlled so as to fall within a predetermined upper limit value. Thereby, the strain on the user's eyes due to viewing the caption 33 and video 32 can be reduced.

The caption parallax determination module 524 can control the depth Z_{N} of the caption 33 so that the depth Z_{N} may not vary for a predetermined period. In this case, the caption parallax determination module 524 varies the depth Z_{N} for displaying the caption 33, not on an image frame by image frame basis, but in every predetermined period. Thus, the caption parallax determination module 524 uses, for example, only for a predetermined period, the depth Z_{N-}1, at which the caption corresponding to the immediately preceding image frame were displayed, as the depth Z_{N} for displaying the caption 33 corresponding to the target image frame. Besides, the caption parallax determination module 524 may execute such control as not to vary the depth Z_{N} of the caption 33 during the period in which the caption 33 indicative of the same content is being displayed. Specifically, during the period in which the same caption 33 is displayed, the captions parallax determination module 524 can continue to display the caption 33 with the same parallax (i.e. at the same depth). To be more specific, when the caption (sub-image) 33 corresponding to the target image frame is the same as the caption 33 corresponding to the immediately preceding image frame, the caption parallax determination module 524 determines the depth Z_{N-1}, at which the caption 33 corresponding to the immediately preceding image frame were displayed, to be the depth Z_{N} for displaying the caption 33 corresponding to the target image frame.

Aside from the caption 33, as regards various kinds of sub-images which are displayed such that they are mixed (superimposed) on the video 32, for instance, an image based on an on-screen display (OSD) signal or an image of a control panel (operation panel) for operating an application program, the depth at which such sub-images are displayed may be determined in the same manner as in the above-described method of determining the depth of the caption 33.

In the above-described example, the description has been given of the structure wherein the left-eye video (right-eye video), in which the video 32 and caption 33 are mixed, is output to the display 15 via the display driver program 13C. Alternatively, such a structure may be adopted that the left-eye video data 44A, right-eye video data 44B, caption data 41A, and parallax information 45 for displaying caption are output to the display driver program 13C. In this case, the display driver program 13C mixes the caption, which has the parallax based on the parallax information 45, with the video based on the left-eye video data 44A or right-eye video data 44B, and causes the display 15 to display the mixed video.

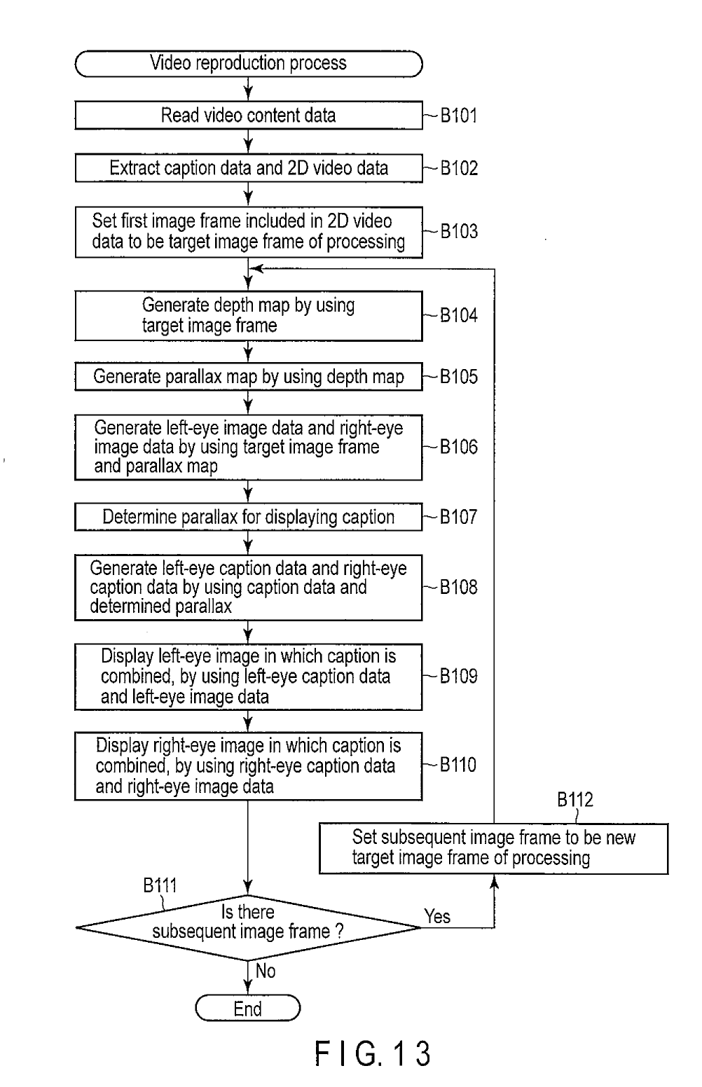

Next, referring to a flowchart of FIG. 13, an example of the procedure of a video reproduction process is described. In the video reproduction process, 3D video 46, in which caption 33 is mixed on video 32, is generated by using input video content data 41.

To start with, the video read module 51 reads the video content 41 from storage media such as a DVD, or from a storage device such as an HDD (block B101). The video read module 51 extracts caption data 41A and 2D video data 41B from the read video content data 41 (block B102). The video read module 51 sets a first image frame, among a plurality of frames based on the extracted 2D video data 41B, to be a target image frame that is a target of processing (block B103). In addition, the video read module 51 sets caption data corresponding to the target image frame, among the extracted caption data 41A, to be target caption data that is a target of processing.

Then, using the target image frame, the depth estimation module 521 generates a depth map 42 by estimating depths (depth positions) of plural pixels included in the image frame (block B104). The parallax calculation module 522 generates a parallax map 43 by calculating a plurality of parallaxes corresponding to the pixels included in the target image frame, by using the generated depth map 42 (block B105). The parallax video generation module 523 generates left-eye video data 44A and right-eye video data 44B, by using the target image frame and the parallax map 43 (block B106).

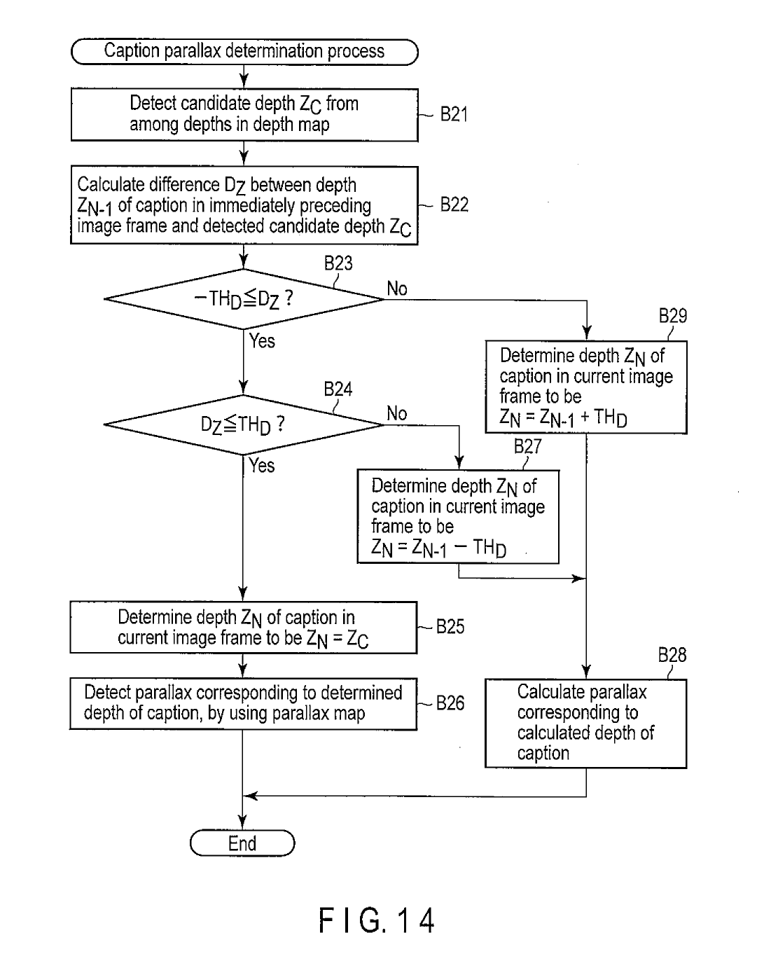

The caption parallax determination module 524 determines a parallax 45 for displaying a caption by using the depth map 42 and parallax map 43 (block B107). The procedure of the process for determining the parallax for displaying caption will be described later with reference to a flowchart of FIG. 14. Then, the parallax caption generation module 525 generates left-eye caption data and right-eye caption data by using the caption data 41A and the determined parallax 45 (block B108).

Subsequently, the display control module 53 displays left-eye video, in which the caption is mixed, on the screen of the display 15 by using the left-eye video data 44A generated by the parallax video generation module 523, and the left-eye caption data generated by the parallax caption generation module 525 (block B109). In addition, the display control module 53 displays right-eye video, in which caption is mixed, on the screen of the display 15 by using the right-eye video data 44B generated by the parallax video generation module 523, and the right-eye caption data generated by the parallax caption generation module 525 (block B110).

Then, the video read module 51 determines whether a subsequent image frame, which follows the current image frame (the target image frame), is present in the plural image frames based on the 2D video data 41B (block B111). If there is the subsequent image frame (YES in block B111), the video read module 51 sets the subsequent image frame to be a new target image frame that is the target of processing (block B112). In addition, the video read module 51 sets caption data corresponding to the target image frame, among the extracted caption data, to be new target caption data that is the target of processing. Then, returning to block B104, the target image frame, which has newly been set to be the target of processing, is subjected to the process for displaying 3D video 46 in which a caption is mixed.

On the other hand, if there is no subsequent image frame (NO in block B112), the process is completed.

By the above-described process, the 3D video 46, in which the caption 33 is mixed on the video 32, can be generated by using the input video content data 41.

FIG. 14 is a flowchart illustrating an example of the procedure of a caption parallax determination process for determining the parallax for displaying a caption.

To start with, the caption parallax determination module 524 detects a candidate depth Z_{C} from among a plurality of depths included in the depth map 42 (block B21). The candidate depth Z_{C} is, for example, a minimum depth among the plural depths included in the depth map 42 (i.e. a depth of a foremost pixel among the pixels in the target image frame). In the meantime, the candidate depth Z_{C} may be a minimum depth of the depths corresponding to the pixels included in the area on the X-Y plane in which the caption is displayed. The detected candidate depth Z_{C} is used as the candidate of the depth at which the caption is displayed in the current frame.

Next, the caption parallax determination module 524 calculates a variation (e.g. an absolute value of a difference) of the candidate depth Z_{C} in the current image frame, relative to a depth Z_{N-1} of a caption in an immediately preceding image frame. Then, the caption parallax determination module 524 determines whether the calculated variation is within the upper limit value (threshold value) TH_{D}. The upper limit value TH_{D} is, for example, 0.16 cm, when it is assumed that video of 60 frames per second is displayed. When the calculated variation is within upper limit value TH_{D}, the caption parallax determination module 524 uses the candidate depth Z_{C} as the depth Z_{N} for displaying the caption in the current image frame. On the other hand, when the calculated variation is greater than the upper limit value TH_{D}, the caption parallax determination module 524 determines the depth Z_{N} so that the variation may fall within the upper limit value TH_{D}.

To be more specific, the caption parallax determination module 524 calculates a difference D_{Z} between the depth Z_{N-1}, at which the caption was displayed in the immediately preceding image frame, and the detected candidate depth Z_{C} (block B22). Then, the caption parallax determination module 524 determines whether the calculated difference D_{Z} is −TH_{D} or more (block B23).

When the calculated difference D_{Z} is −TH_{D} or more (YES in block B23), the caption parallax determination module 524 determines whether the calculated difference D_{Z} is TH_{D} or less (block 324). When the calculated difference D_{Z} is TH_{D} or less (YES in block B24), the caption parallax determination module 524 determines the candidate depth Z_{C} to be the depth Z_{N} for displaying the caption in the current image frame (block B25). Then, using the parallax map 43, the caption parallax determination module 524 detects the parallax corresponding to the determined depth Z_{N} (=Z_{C}) of the caption (block B26).

On the other hand, if the calculated difference D_{Z} is greater than TH_{D} (NO in block B24), the caption parallax determination module 524 calculates the depth Z_{N} for displaying the caption in the current image frame by the following equation (block B27):

Z_{N}=Z_{N-1}−TH_{D}.

Then, the caption parallax determination module 524 calculates the parallax corresponding to the calculated depth Z_{N} of caption (block B28).

If the calculated difference D_{Z} is less than −TH_{D} (NO in block B23), the caption parallax determination module 524 calculates the depth Z_{N} for displaying the caption in the current image frame by the following equation (block B29):

Z_{N}=Z_{N-1}+TH_{D}.

Then, the caption parallax determination module 524 calculates the parallax 45 corresponding to the calculated depth Z_{N} of the caption (block B28).

By the above-described process, the parallax 45 for displaying the caption 33 can be determined. In the meantime, when the process is executed on the first image frame in the 3D video data, a predetermined value may be used as the depth Z_{N-1}, at which the caption was displayed in the immediately preceding image frame. In addition, in the first image frame, a minimum depth of the depths included in the depth map 42, or a minimum depth of the depths corresponding to the pixels included in the area on the X-Y plane in which the caption is displayed, may be used as the depth Z_{N} for displaying the caption.

As has been described above, according to the present embodiment, when 3D video is displayed, a caption can be displayed at a depth at which the user can easily visually recognize the caption. The video content reproduction program 13B displays video (i.e. left-eye video and right-eye video) in which the caption 33 is superimposed on the video 32. The caption 33 is dynamically displayed at a position where the caption 33 is easily visually recognized in accordance with the depth of the video 32. The depth of the caption 33 is set, for example, at a position where the caption 33 does not sink in the video 32, and the distance in the depth direction between the video 32 and caption 33 is not excessively large. Moreover, the variation of the depth of the caption between image frames is controlled so as to fall within a predetermined upper limit value. Thereby, the strain on the user's eyes due to viewing the caption 33 and video 32 can be reduced.

All the procedures of the video reproduction process in this embodiment may be executed by software. Thus, the same advantageous effects as with the present embodiment can easily be obtained simply by installing a program, which executes the procedures of the video reproduction process, into an ordinary computer through a computer-readable storage medium which stores the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to reproduce three-dimensional video by using video content data comprising video data and sub-image data, the apparatus comprising:
a depth estimation module configured to estimate a plurality of depths corresponding to a plurality of pixels in a first image frame of a plurality of image frames of the video data, the first image frame being a target of processing;
a parallax calculation module configured to calculate a plurality of parallaxes corresponding to the plurality of pixels by using the plurality of depths;
a video generation module configured to generate left-eye video data and right-eye video data by using the video data and the plurality of parallaxes;
a sub-image parallax determination module configured to determine a first depth for displaying a sub-image based on the plurality of depths, and to determine a first parallax corresponding to the sub-image by using the first depth;
a sub-image generation module configured to generate left-eye sub-image data and right-eye sub-image data by using the sub-image data and the first parallax; and
a display control module configured to display a left-eye image by using the left-eye video data and the left-eye sub-image data, and to display a right-eye image by using the right-eye video data and the right-eye sub-image data.

2. The electronic apparatus of claim 1, wherein the sub-image parallax determination module is configured to set the first parallax to a parallax of the plurality of parallaxes, the first parallax corresponding to the first depth.

3. The electronic apparatus of claim 2, wherein the sub-image parallax determination module is configured to calculate an absolute difference between the first depth and a second depth at which a sub-image corresponding to a second image frame immediately preceding the first image frame was displayed, and to vary the first depth in such a manner that the calculated absolute difference becomes a threshold or less if the calculated absolute difference is greater than the threshold.

4. The electronic apparatus of claim 2, wherein the sub-image parallax determination module is configured to set the first depth to a second depth at which a sub-image corresponding to a second image frame immediately preceding the first image frame was displayed, during a predetermined period.

5. The electronic apparatus of claim 2, wherein the sub-image parallax determination module is configured to set the first depth to a minimum depth of the plurality of depths.

6. The electronic apparatus of claim 2, wherein the sub-image parallax determination module is configured to detect depths from among the plurality of depths, and to set the first depth to a minimum depth of the detected depths, the detected depths corresponding to an area on a screen in which the sub-image is displayed.

7. The electronic apparatus of claim 2, wherein the sub-image parallax determination module is configured to set the first depth to a second depth at which a sub-image corresponding to a second image frame immediately preceding the first image frame was displayed if the sub-image corresponding to the first image frame is identical to a sub-image corresponding to the second image frame.

8. The electronic apparatus of claim 2, wherein the sub-image data comprises caption data for displaying a caption.

9. The electronic apparatus of claim 2, wherein the sub-image data comprises data of a control panel for operating an application program.

10. The electronic apparatus of claim 2, wherein the sub-image data comprises an on-screen display signal.

11. An image processing method of reproducing three-dimensional video by using video content data comprising video data and sub-image data, the method comprising:
estimating a plurality of depths corresponding to a plurality of pixels in a first image frame of a plurality of image frames of the video data, the first image frame being a target of processing;
calculating a plurality of parallaxes corresponding to the plurality of pixels by using the plurality of depths;
generating left-eye video data and right-eye video data by using the video data and the plurality of parallaxes;
determining a first depth for displaying a sub-image based on the plurality of depths, and determining a first parallax corresponding to the sub-image by using the first depth;
generating left-eye sub-image data and right-eye sub-image data by using the sub-image data and the first parallax; and
displaying a left-eye image by using the left-eye video data and the left-eye sub-image data, and displaying a right-eye image by using the right-eye video data and the right-eye sub-image data.

12. A non-transitory computer readable medium having stored thereon a program for reproducing three-dimensional video by using video content data comprising video data and sub-image data, the program being configured to cause the computer to:
estimate a plurality of depths corresponding to a plurality of pixels in a first image frame of a plurality of image frames of the video data, the first frame being a target of processing;
calculate a plurality of parallaxes corresponding to the plurality of pixels by using the plurality of depths;
generate left-eye video data and right-eye video data by using the video data and the plurality of parallaxes;
determine a first depth for displaying a sub-image based on the plurality of depths, and determine a first parallax corresponding to the sub-image by using the first depth;
generate left-eye sub-image data and right-eye sub-image data by using the sub-image data and the first parallax; and
display a left-eye image by using the left-eye video data and the left-eye sub-image data, and display a right-eye image by using the right-eye video data and the right-eye sub-image data.
